(19) United States
(12) Patent Application Publication
(10) Pub. No.: US 2010/0332269 A1
(43) Pub. Date: Dec. 30, 2010

(54) METHOD AND SYSTEM FOR MODELING THE FINANCIAL REQUIREMENTS OF AN INDUSTRIAL MACHINE

(75) Inventors: Victor F. Russo, Marietta, GA (US); Anita Ahluwalia, Tucker, GA (US); Richard F. Beach, Kennesaw, GA (US); Reginald J. Acloque, Mableton, GA (US); Paul J. Ulshafer, Suwanee, GA (US); Henry P. Berard, Kennesaw, GA (US); Jonathan Calhoun, Marietta, GA (US); Gautam C. Bhat, Banglore (IN)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/492,474

(22) Filed: Jun. 26, 2009

(51) Int. Cl. G06Q 10/00

(52) U.S. Cl. 705/7

(57) ABSTRACT

An embodiment of the present invention may provide an integrated platform for assessing the current profitability of a previously executed service contract. Essentially, the present invention provides a user a simple yet effective means to evaluate and reassess whether a service contract for an industrial machine may remain profitable over the duration. An embodiment of the present invention may provide a method or system for forecasting and modeling the financial and operational requirements of an industrial machine. An embodiment of the present invention may integrate engineering data, equipment data, financial information, contractual information, and asset utilization information to reassess the financial and operational requirements of the industrial machine, for a current environment.

### BACKGROUND OF THE INVENTION

The present invention relates to industrial machines, and more specifically to a method and system of modeling the financial requirements associated with a contract associated with the operation of an industrial machine.

Industrial machines, such as, but not limiting of, turbomachines, and other energy producing machines, are typically associated with a service contract. Generally, the service contract may govern the operation, reliability, and performance of the industrial machine, over a period of time. The service contract is also known as: a long-term maintenance contract, a contractual service agreement, an operational and maintenance agreement, or the like. Typically, the period of the service contract is for multiple years.

A variety of factors may determine whether the service contract may prove to be more or less profitable than originally anticipated. These factors may relate to operation and/or financial requirements of the industrial machine. Operationally, the industrial machine may experience unanticipated outages or other events that limit operation. On financial requirements, various penalties, repair costs, and/or downtime may effect revenue generation and other financial requirements.

Currently known systems do not integrate the operational side of the industrial machine and the financial side of the same industrial machine in a simple manner allowing for analyzing the current profitability of the service contract. The operational side may involve the engineering, operability, and other technical aspects related to operation of the industrial machine. The financial side may involve the costs associated with replacing parts, performing a service event, and/or a repair event, loss revenue, or the like.

Operators of the currently known systems may experience difficulties in determining the long-term profitability of the service contract. The methods or systems associated with the operational aspects are not commonly integrated with the financial aspects of industrial machine. The currently known systems may not allow users to create a finance model of the service contract; allowing for accurately estimating how the service contract may perform over the duration of the contract. The currently known systems may not allow for updating the operational and/or financial aspects to reflect the current environment. The currently known systems may not allow for updating the service contract to reflect the actual performance of the industrial machine. The currently known systems may not allow for a simple way of performing a financial risk analysis on a portfolio of similar service contracts.

For the foregoing reasons, there may be a desire for an improved method of determining the long-term profitability associated with a service contract. The method and system should integrate the operational and financial aspects associated with the industrial machine. The method and system should be portable to allow for modeling multiple industrial machines that may be co-located on the same site or located across multiple sites.

### BRIEF DESCRIPTION OF THE INVENTION

In accordance with an embodiment of the present invention, a method of modeling financial requirements associated with an industrial machine, the method comprising: providing an industrial machine; providing at least one modeling engine for modeling the industrial machine; receiving a plurality of engineering data related to the industrial machine; receiving a plurality of operating data on the industrial machine; receiving a plurality of financial information related to the industrial machine; and accessing contractual requirements associated with the industrial machine; wherein the modeling engine develops a financial model and generates a report on the financial requirements of the industrial machine

In accordance with an alternate embodiment of the present invention, a system for modeling financial requirements associated with an industrial machine, the system comprising: an industrial machine, wherein the industrial machine provides a plurality of operating data related to a processor; at least one modeling engine for modeling the operational and financial activities of the industrial machine, wherein the at least one modeling engine is integrated with the processor, and wherein the at least one modeling engine performs the steps of: receiving a plurality of engineering data related to the industrial machine; receiving a plurality of financial information related to the industrial machine; and accessing contractual requirements associated with the industrial machine; wherein the modeling engine develops a financial model and generates a report on the financial requirements of the industrial machine.

### BRIEF DESCRIPTION OF THE DRAWINGS

These and other features, aspects, and advantages of the present invention will become better understood when the following detailed description is read with reference to the accompanying drawings in which like characters represent like elements throughout the drawings.

FIG. 1 is a schematic illustrating an overview of an embodiment of the present invention.

FIG. 2 is a block diagram illustrating an overview of an embodiment of the present invention.

FIG. 3 is a flowchart illustrating an embodiment of a modeling engine, in accordance with an embodiment of the present invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the Figures. Indeed, the element or elements of an embodiment of the present invention may be oriented in various directions and the terminology, therefore, should be understood as encompassing such variations unless specified otherwise.

As used herein, an element or step recited in the singular and preceded with “a” or “an” should be understood as not excluding plural elements or steps, unless such exclusion is explicitly recited. Furthermore, references to “an embodiment” of the present invention are not intended to exclude additional embodiments incorporating the recited features.

An embodiment of the present invention may provide an integrated platform for assessing the current profitability of a previously entered service contract. Essentially, the present invention provides a user a simple yet effective means to evaluate and reassess whether a service contract for an industrial machine may remain profitable over the duration. An embodiment of the present invention may provide a method or system for forecasting and modeling the financial and operational requirements of an industrial machine.

The present invention has the technical effect of integrating operational data and financial data associated with the industrial machine to determine the long-term profitability of a service contract. Here, an embodiment of the present invention may integrate engineering data, equipment data, financial information, contractual information, and asset utilization information to reassess the financial and operational requirements of the industrial machine, for a current environment.

An industrial machine may be considered any machine, device, component, or the like, that may be used with a process that generates, transform, distributes, or transmits any form of energy. For example, but not limiting of, an industrial machine may include: a turbomachine, a generator, a motor, a gas turbine, a steam turbine, a transformer, a mechanical drive, a compressor, a heat recovery steam generator, an aircraft engine, an aero-derivative turbomachine, or combinations thereof.

The embodiments of the present invention described below may discuss a single industrial machine. This is not intended to be a limitation on the present invention. Furthermore, alternate embodiments of the present invention, not described below, may be integrated with multiple industrial machines. The present invention is not limited industrial machines that are located on the same site. The present invention may be integrated with industrial machines located on multiple sites.

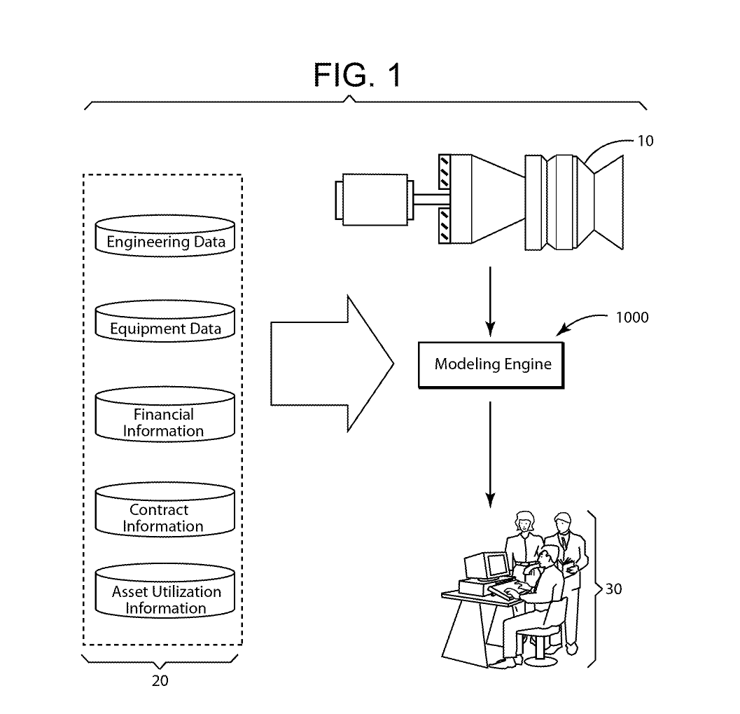

Referring now to the Figures, where the various numbers represent like elements throughout the several views, FIG. 1 is a schematic illustrating an overview of an embodiment of the present invention. FIG. 1 illustrates an embodiment of a modeling engine 1000, which may comprise the form of a memory, or other storage, within at least one processor. The modeling may receive data, directly or indirectly, from the industrial machine 10, and a plurality of associated data 20.

As discussed, the industrial machine 10 may be considered any machine, device, component, or the like, that may be used with a process that generates, transform, distributes, or transmits any form of energy. Generally, the associated data 20 may comprise data on the operational and financial aspects of the industrial machine 10. The associated data 20 may include multiple categories such as, but not limiting of: engineering data, equipment data, financial information, contract information, and asset utilization information. The following provides a general description of each category.

The engineering data may include information on the technical aspects of the industrial machine 10 or the fleet that the industrial machine 10 may be associated. For example, but not limiting of, the engineering data may include temperatures, pressure, flow rates, and other information related to the operation of the industrial machine 10. The equipment data may include information related to the specific model number, serial number, and the like, of the industrial machine 10. For sites employing multiple industrial machines 10, an embodiment of the modeling engine 1000 may receive equipment data on each industrial machine 10. The financial information may include data on the costs associated with industrial machine 10. These costs may include, but are not limited to, purchase price, operational expenses, revenue generation, repair and service costs, and the like. The contract information may include data on the related service contract of contracts. The asset utilization may include data on the performance, usage, and operational environment of the industrial machine 10.

The modeling engine 1000 may generate a report after performing analytics on the data from industrial machine 10 and the associated data 20. A user at the terminal 30 may select the type of report. In an embodiment of the present invention, the modeling engine 1000 may automatically generate and transmit the report to the terminal. The terminal may be located adjacent the modeling engine 1000 or may be remotely located.

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium. As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram blocks.

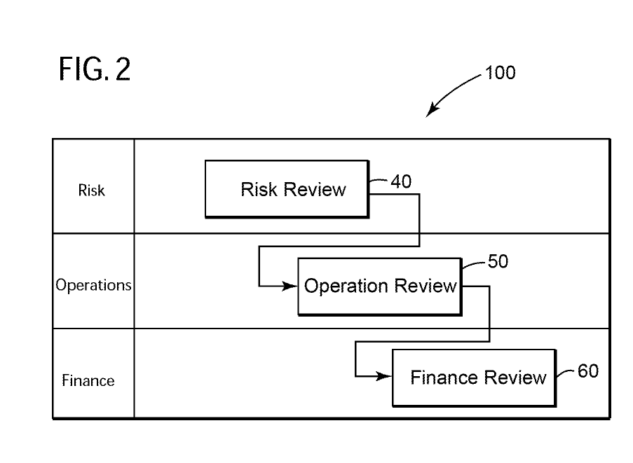

Referring again to the Figures, FIG. 2 is a block diagram illustrating an overview of an embodiment of the present invention. An embodiment of the modeling engine 1000 may perform at least three major functions, a risk review 40, an operational review 50, and a finance review 60. The risk review 40 may include, but is not limited to, reviewing: engineering data; the cost associated with a change in the price of a part, repair, services, or the like; and associated pricing changes. The operation review 50 may include, but is not limited to, reviewing: a model of the industrial machine 10: reviewing and/or creating a margin review; and entering/updating billing data. The finance review 60 may include, but is not limited to, reviewing: a previous contractual margin, determining a new contractual margin, calculating sales, determining a billing adjustment, and determining whether an adjustment to the service contract is required.

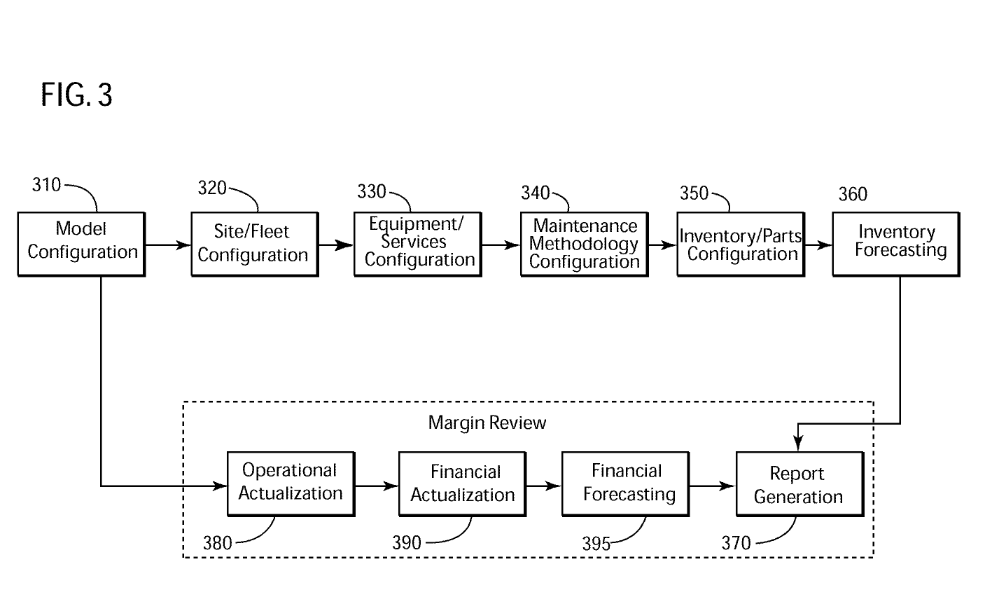

FIG. 3 provides a detailed description of an embodiment of the modeling engine 1000, whereas FIG. 2 provided a conceptual overview of the modeling engine 1000. FIG. 3 is a flowchart illustrating an embodiment of a modeling engine 1000, in accordance with an embodiment of the present invention. FIG. 3 illustrates the steps that the modeling engine 1000 may perform to analyze a service contract in view the operational and financial data of the industrial machine 10.

In step 310 the modeling engine 1000 may determine a model configuration. The model configuration may include information such as, but not limiting of, customer identification, the dates of the service contract, the type of service contract, pricing, or the like. Here, a user may, for example, but not limiting of, create a new model, modify an existing model, or delete an existing model. An embodiment of the present invention may allow a user to incorporate an existing model into a new model. Another embodiment of the present invention may include a search feature allowing for a user to determine whether a similar model may exist.

In step 320 the modeling engine 1000 may determine a site and/or fleet configuration. A site configuration may include the customer site where the industrial machine(s) 10 are located. A fleet configuration may include multiple sites having similar industrial machines 10. In an embodiment of the present invention, a user may select a site/fleet configuration from a dropdown list and/or search for a specific site/fleet configuration. Alternatively, an embodiment of the present invention may allow the user to create a new site/fleet configuration.

In step 330, the modeling engine 1000 may determine an equipment/service configuration. Here, a user may configure the type of services that are to be performed under the services contract. For example, but not limiting of, if the industrial machine 10 is a gas turbine, the user may enter or update an inspection service common to the gas turbine. Step 330 may also allow a user to select a specific industrial machine 10 where the model includes multiple industrial machines 10. Furthermore, step 330 may also allow for entering and/or editing details on the industrial machine 10, such as, but not limiting of, prior repair history, or the like.

In step 340, the modeling engine 1000 may configure a maintenance methodology for the equipment/service configured in step 330. Here, the modeling engine 1000 may allow for editing/selecting/or importing the maintenance methodology. Next, when an exiting maintenance methodology is selected, an embodiment of the present invention may allow for a user to adjust and/or add maintenance activities.

In step 350, the modeling engine 1000 may configure an inventory and/or parts for the industrial machine 10. An embodiment of the present invention may determine whether a pail is needed for a service or for spares. Here, the modeling engine 1000 may receive data on the availability and cost of the part (s).

In step 360, the modeling engine 1000 may forecast the inventory for the industrial machine 10. For example, but not limiting of, an embodiment of the present invention may project a current usage and future need for consumables and/or special parts. Furthermore, the forecasting may include changes in the pricing of the forecasted parts. In an embodiment of the present invention, a report on the inventory forecast may be generated. Here, step 370 may occur outside of the margin review process. This may allow a user to generate a plurality of user-selected reports on the inventory.

Steps 370-395, may collectively comprise a margin review; which may provide a very useful benefit to the user. A margin review may be considered a way of assessing the profitability of the service contract, under a current environment. There are many known ways to conduct a margin review, however the accuracy of such review tends to be heavily dependent of the data used. Here, the modeling engine 1000 may automatically perform the margin review after receiving the current data used and/or generated in steps 310-360. This data may be relatively current, allowing for a more accurate margin review. An embodiment of the present invention may automatically perform a margin review of the contract on an interval basis or when a significant change in the data, such as, but not limiting of, price, has occurred.

In step 380, the modeling engine 1000 may perform an operational actualization of the industrial machine 10. Operational actualization may be considered a process that updates operating data within the modeling engine 1000. This may include, but is not limited to, actual and proposed future operating data, current inventories, actual events, equipment validation, and requirements for custom parts. Step 380 may also determine whether an operational assumption that may have been considered when the contract was formed. Step 380 may also determine whether the services contract may require a renegotiation in light of current environment.

In step 390, the modeling engine 1000 may perform a financial actualization of the industrial machine 10. Financial actualization may be considered a process that updates financial data within the modeling engine 1000. This may include, but is not limited to, actual sales and costs for planned, unplanned, and extra work; selection of a new catalog; and entering and/or updating a billing stream. Here, the work may include: services, repairs, replacement, and the like.

In step 395, the modeling engine 1000 may forecast the finances for the industrial machine 10. For example, but not limiting of, an embodiment of the present invention may project a change in the pricing, costs, or other financial requirements. The financial forecasting may serve as an accurate guide of future financial requirements based on the most current data and analytics performed by the modeling engine 1000.

As discussed, in step 370, the modeling engine 1000 may generate a report. Here, during or after the margin review process a user may generate a plurality of reports covering financial and operational aspects of the industrial machine 10. In an embodiment of the present invention, reports on the financial aspects may include, but are not limited to: quarterly payments, annual costs, margin reviews, comparison reports, and the like. In an embodiment of the present invention, reports on the operational aspects may include, but are not limited to: parts, repairs, services, contracts, operations, and the like.

The flowcharts and step diagrams in the figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claim is:

1. A method of modeling financial requirements associated with an industrial machine, the method comprising:
providing an industrial machine;
providing at least one modeling engine for modeling the industrial machine;
receiving a plurality of engineering data related to the industrial machine;
receiving a plurality of operating data on the industrial machine;
receiving a plurality of financial information related to the industrial machine; and
accessing contractual requirements associated with the industrial machine;
wherein the modeling engine develops a financial model and generates a report on financial requirements of the industrial machine.

2. The method of claim 1, wherein the industrial machine comprises at least one of: a turbomachine, a generator, a motor, a gas turbine, a steam turbine, a transformer, a mechanical drive, a compressor, a heat recovery steam generator, an aircraft engine, an aero-derivative turbomachine, or combinations thereof.

3. The method of claim 1, wherein the financial requirements comprise at least one of: a financial cash flow, an operational event, a transaction involving a part, service, or repair for the industrial machine, or the like.

4. The method of claim 1, wherein the modeling engine performs the steps of:
a. determining a configuration of the financial model;
b. determining a configuration of a fleet related to the industrial machine;
c. determining a configuration of the industrial machine;
d. determining a maintenance methodology of the industrial machine; and
e. forecasting the inventory of the part associated with the industrial machine.

5. The method of claim 4, wherein the modeling engine performs a margin review, wherein the margin review comprises the steps of:
a. receiving a plurality of operational data related to the industrial machine;
b. receiving a plurality of financial data related to the industrial machine;
c. forecasting a future financial requirement of the industrial machine; and
d. generating a report based on the data from at least one of: the operational data, the financial data, and combinations thereof.

6. The method of claim 5, wherein the report comprises at least one of: a payment schedule; a catalog; a margin review; a repair estimate; or a contract.

7. The method of claim 1, wherein the contractual requirements associated with the industrial machine comprise at least one of: an operational and maintenance agreement; a long term services agreement; or the like.

8. The method of claim 1 further comprising at least one of the following steps:
a. creating a new financial model;
b. modify the financial model; or
c. deleting the financial model.

9. The method of claim 5, wherein the step of receiving the plurality of operational data comprises at one least of:
a. receiving current operating data on the industrial machine;
b. receiving future operating data on the industrial machine;
c. receiving current inventory data on the fleet associated with industrial machine;
d. validating the configuration of the industrial machine; or
e. modifying a contract associated with the industrial machine.

10. The method of claim 6, wherein the step of receiving the plurality of financial data comprises at least one of:
a. determining actual sales data associated with a planned service associated with the industrial machine;
b. determining actual sales data associated with an unplanned service associated with the industrial machine;
c. providing financial data associated with a billing stream associated with the industrial machine.

11. A system for modeling financial requirements associated with an industrial machine, the system comprising:
an industrial machine, wherein the industrial machine provides a plurality of operating data related to a processor;
at least one modeling engine for modeling the operational and financial activities of the industrial machine, wherein the at least one modeling engine is integrated with the processor, and wherein the at least one modeling engine performs the steps of:
receiving a plurality of engineering data related to the industrial machine;
receiving a plurality of financial information related to the industrial machine; and
accessing contractual requirements associated with the industrial machine;
wherein the modeling engine develops a financial model and generates a report on financial requirements of the industrial machine.

12. The system of claim 11, wherein the industrial machine comprises at least one of: a turbomachine, a generator, a motor, a gas turbine, a steam turbine, a transformer, a mechanical drive, a compressor, a heat recovery steam generator, an aircraft engine, an aero-derivative turbomachine, or combinations thereof.

13. The system of claim 11, wherein the financial requirements comprise at least one of; a financial cash flow, an operational event, a transaction involving a part, service, or repair for the industrial machine, or the like.

14. The system of claim 11, wherein the processor is integrated with at least one terminal, wherein the terminal allows for accessing the modeling engine.

15. The system of claim 11, wherein the modeling engine performs a margin review, and wherein the margin review comprises the steps of:
a. receiving a plurality of operational data for determining an operational history of the industrial machine;
b. receiving a plurality of financial data for determining a financial history of the industrial machine;
c. forecasting a future financial requirement of the industrial machine; and
d. generating a report based on the data from at least one of: the operational history, the financial history, and combinations thereof.

16. The system of claim 15, wherein the report comprises at least one of: a payment schedule; a catalog related to the part; a margin review; a repair or replace estimate; and a contract related to at least one: an order for the part, an order for a service, an order for a repair.

17. The system of claim 11, wherein the contractual requirements associated with the industrial machine comprise at least one of: an operational and maintenance agreement; a long term services agreement; or the like.

18. The system of claim 14, wherein the at least one terminal is located adjacent a remote monitoring and diagnostics center.

19. The system of claim 18, wherein the at least one terminal is integrated with a control system of the industrial machine, wherein the control system comprises at least one of: a powerplant control system, a distributed control system, a turbine control system, or the like.

20. The system of claim 16, wherein the at least one modeling engine receives data from a plurality of industrial machines, and wherein the plurality of industrial machines are located in at least one of: a same location, multiple locations, or combinations thereof.
